(19) United States
(12) Patent Application Publication
(10) Pub. No.: US 2012/0052410 A1
(43) Pub. Date: Mar. 1, 2012

(54) High-Volume-Manufacture Fuel Cell Arrangement and Method for Production Thereof

(76) Inventors: Maria Simpson, Washington, DC (US); Torrence Duffy, Washington, DC (US); Charles Simpson, Washington, DC (US)

(21) Appl. No.: 13/266,792

(22) PCT Filed: Apr. 30, 2009
(86) PCT No.: PCT/US09/42198

§ 371 Date: Oct. 28, 2011

(51) Int. Cl. H01M 8/10; H01M 8/24; H01M 8/00

(52) U.S. Cl. 429/455; 429/479; 429/482; 429/535

(57) ABSTRACT

A fuel cell which is producible in high volume with electrolyte, positive electrode, and negative electrode components, which incorporate structure, external electrical connections, internal fuel feed passages, fuel distribution passages, oxidizer feed passages, oxidizer distribution passages, return passages, and exhaust passages to form a simple assembly which can be formed into a stack. The fuel cell can utilize either a rigid or flexible electrolyte.

### TECHNICAL FIELD

The present invention relates to a fuel cell and a manufacturing method therefor. More particularly, the present invention relates to a fuel cell arrangement which is practicably capable, for the first time, of being manufactured in high volume at relatively low cost, and to a high volume process which provides robust and dependable fuel cell construction.

### BACKGROUND

Experimental fuel cells were first produced in the mid-1800's as research expanded in electrochemical storage devices. That early work lead to present-day storage batteries which have, however, progressed relatively little over the past hundred years. When NASA needed a compact, efficient electrical generating system in the 1960's for the U.S. space program, the fuel cell became the energy storage device of choice because cost was not a primary factor.

Generally speaking, fuel cells and storage batteries both produce electricity in essentially the same manner. That is, their oxidizing material (fuel) at a source electrode (cathode) produces positive ions, and reducing material (oxidizer) at the return electrode (anode) produces negative ions. These positive and negative ions combine in an electrolyte forming new stable materials and completing the electrical path.

A battery's source of fuel and oxidizer are the electrode materials which, when depleted, render it inoperative. The electrodes in a fuel cell are, however, permanent structures which provide an electrical path and contribute nothing to the chemical activity. Catalysts initiate the oxidation process which is maintained as the fuel and oxidizer are replenished from external sources. Most present-day fuel cells use hydrogen as the fuel and air as the oxidizer.

An atomic-level, hydrogen permissible filter (Proton Exchange Membrane or PEM) greatly simplifies a fuel cell's structure. In the PEM fuel cell, a hydrogen-rich fluid is fed to the negative electrode (cathode) side of the PEM where a catalyst causes hydrogen atoms to separate from the surrounding fluid material as the electrons of the separated hydrogen atoms are surrendered to the negative electrode prior to passing through the PEM. The oxygen in the air gains electrons through catalytic activity at the positive electrode (anode) side of the PEM. The hydrogen and oxygen atoms (ions) combine, completing the cycle and the resultant is expelled.

The PEM in many fuel cell systems is a thin plastic film commercially available, for example, from DuPont and Gore Industries and similar in handling characteristics to plastic food wrap. Many mechanical difficulties are thus associated with this “plastic wrap”-type PEM. A complex, costly, physical supporting structure is required, including both fuel and cooling-fluid routing.

Electrolyte, PEM and separator treatment demand precision handling which makes final assembly extremely difficult. The process of sealing and connecting the cell stack is the most demanding because the PEM and separator are sensitive to both fluid-wetting and high temperatures. Noble-metal catalysts and easily damaged carbon-compound electrodes contribute significantly to costs, due both to high-priced material and yield losses. The final difficulty is the assembly and sealing of the cells because joining temperatures and pressure must be kept extremely low to avoid destroying the components.

The use of fuel cells for automobiles presents another tremendous challenge. For example, a minimum life expectancy for a family vehicle with only routine maintenance is 100,000 miles over a 5-year span. An automobile must start and operate under a wide variety of adverse conditions, and the drive package must be compact enough to allow placement conveniently away from the passenger compartment and yet be readily accessible for maintenance. The drive package must work safely and start quickly even when abused or slightly damaged. Moreover, there must be compliance with stringent emission standards. From an economic perspective, fuel cells have to compete with current drive-train technology and component replacement, rather than complete-system replacement, is essential.

A tremendous amount of research and development has been devoted to automotive fuel cells. However, prior to the present invention, such R & D has failed thus far to produce economical practicable fuel cell products, because it has concentrated largely on the fundamental scientific principles and basic developments such as perfluorosulfonic-acid based PEMs. On one hand, observed current densities for PEM cells vary from around 25 mA/cm² to 4000 mA/cm². On the other hand, achieving such current densities has generally involved using graphite as the conductive electrode material.

Carbon's natural clumping and granular structure present a large porous surface area lattice through which fuel and oxidizer flow. If this large surface area is treated with catalyst material after forming the carbon electrode, large amounts of noble metal are used. If the carbon is blended with the catalyst and bonding agents prior to forming or attaching as an electrode, the electrical resistance increases. Because of the already-high internal resistance of carbon, any external resistance created at the interface substantially increases the energy loss as heat.

Furthermore, the assembly of PEM electrolyte and carbon electrode cells into usable stacks has proved difficult from the viewpoint of the electrical connections, the fluid seals, and the structure to keep it in place. Also, PEMs rapidly deteriorate as the temperature approaches 90° C. Separate cooling components and complex hydration systems which have been acceptable in the lab are certainly less so in the commercial world. Ceramic electrolyte development has been curtailed due to the perception of high cost and production difficulties.

We have recognized that a key requirement of fuel cells, particularly for automotive applications where cost is a major factor, is that they be mass producible but of consistent high quality, characteristics heretofore unavailable with conventional fuel cells.

### SUMMARY OF THE INVENTION

In accordance with the present invention, fuel cell fabrication, process and assembly methods are disclosed with the objective of advantageously eliminating many of the components and most of the costly process steps of conventional fuel cell fabrication in order to substantially reduce costs and increase manufacturability without sacrificing the advantages of currently used fuel cells.

Another object of the present invention is to provide a fuel cell in which the mechanical structure, frame and closure is an integral part of the components, and most particularly, the electrodes for use with flexible electrolytes.

Still another object of the present invention is to provide a fuel cell in which the cell-to-cell and outside interconnecting passages for the fluid inputs and outputs are integrated.

Yet another object of this invention is to provide a fuel cell in which the electrolyte can be placed on either side of the electrode which allows alternate assembly of the electrodes with the electrolytes, negative electrode, electrolyte, positive electrode, electrolyte, negative electrode, etc., and therefore reduces to about one half plus one the number of electrodes needed in current stacked or tandem fuel cells.

Another object of this invention is to provide a fuel cell in which the number of separator plates is reduced for flexible or otherwise difficult to maintain electrolytes or completely eliminated, for rigid structural electrolytes.

Another object of the present invention is the provision of a fuel cell in which the seal or closure at all passages, enclosures, vias and surrounds can be accomplished simultaneously and in any of the known methods such as compressible formed material, adhesives, chemical bonding, eutectic and metal bonding etc.

Another object of this invention is to provide a fuel cell in which the catalytic material can be applied directly to either the electrolyte or the electrode structures using the most inexpensive and reliable known methods such as sputtering, selective plating, chemical vapor deposition, printing etc.

Still another object of the present invention is the provision of a fuel cell in which the electrode electrical connections are externally selectable and connectable to establish the desired electrical power output from interconnected cells.

A further object of this invention is the provision of a fuel cell in which the component alignment advantageously occurs by mechanical design.

A yet further object of this invention is the provision of a fuel cell in which the electrodes are formed equally well by any of several known methods, such as stamping, sintering, casting, molding and multi-layer laminating and etching similar to circuit board technology.

Another object of this invention is the provision of a fuel cell in which the ionization of the fuel and oxidizer is accomplished either at the electrolyte face for cell simplicity or moved some distance to enhance the chemical process and expellation of the spent reaction.

The foregoing objectives for producing, in high volume, fuel cell components which incorporate structure, external electrical connection, internal fuel and oxidizer passage and distribution, exhaust passage and outlet and simple stack alignment assembly have been achieved according to one embodiment in the form of three singular, unitized fuel cell components, namely an electrolyte, a positive electrode and a negative electrode, are complete and ready for stacking, seal or joinery at the exit of their simple process lines. Each of the components works with all of the known electrochemical and electrolyte processes. These components can be stacked to form a complete, alignable, repeatable fuel cell module with internal oxidizer and fuel passage and distribution, internal exhaust passages and external electrical interconnect.

A further object of the present invention is to overcome the current difficulties of electrical interconnect, structural integrity, fuel and oxidizer distribution, maintenance and replacement while produced by a high speed, high volume process such as stamping for metals and suitable plastics and rotary the forming for partially staged ceramics and thermal set polymers.

In one embodiment of the present invention, the electrolyte is produced from a single piece of inert structural material which is processed to allow the passage of only migrating ions, and to which conductive material and the appropriate catalysts are applied to each side to provide a single inclusive unit, i.e. electrolyte, and positive and negative electrodes. Non-conductive fuel and oxidizer distribution plates are added to complete the cell.

The electrolyte is configured such that the main structural component is a peripheral surround of the processing area which is impermeable, includes external electrical connecting tabs, and provides an attachment and seal or closure area. Seal areas are also provided at strategic internal locations for inter-cell fluid passages. The large operating area of the electrolyte is processed to be ion permissive and provides attachment surfaces for conductive electrode and catalytic materials.

In yet another embodiment, the electrode is produced from a single piece of electrically conductive material such that the principal structural component is a peripheral surround of the processing area which is impermeable, includes external electrical connecting tabs and provides an attachment and seal area. Seal areas are also provided at strategic internal locations for inter-cell fluid passages. The large operating area of the electrode is permeable or otherwise open to fluid flow in all directions, transverse, radial and lateral and provides an attachment surface for a catalytic material.

The differences between the positive and negative electrodes are in the location and/or shape of the external electrical connectors and, if applied, specific catalysts. Although it is not necessary to attach the catalysts to the electrode structures, this ability to do so allows the use of less robust mechanical electrolytes which could not support attachment of catalysts to them. The electrodes are configured to have electrolytes placed on either side thereof and reduce volume while increasing fuel cell efficiency.

In yet another embodiment, the electrode is produced from three pieces of material which are separately formed and then joined together to form a unitized structure. The two active pieces are identical, interchangeable, reversible, and are formed and configured by the same processes. Each of the active pieces are produced from a single electrically conductive material such that the principle structural component is a peripheral surround of the processing area which is impermeable, includes external electrical connecting tabs and provides an attachment and seal (closure) area. Seal (closure) areas are also provided at strategic internal locations for inter-cell fluid passages.

The third piece is a distribution plate produced from either a single electrically conductive material which joins the active pieces, thereby producing a common level electrode, or from a single non-conductive material which separates the two active pieces producing two electrically separate electrodes. The distribution plate has a principle structural component constituting a peripheral surround of the processing area which is impermeable, may include external electrical connecting tabs and provides an attachment and seal (closure) area. Seal (closure) areas are also provided at strategic internal locations for inter-cell fluid passages.

In a yet further embodiment, the electrolyte is produced from a single piece of inert non-structural material which is processed to allow the passage of migrating ions in specified regions. The electrolyte is attached directly to one or both of the electrodes as described in the second and third embodiments herein. In one instance the associated catalysts are applied directly to each electrode structure and the non-structural electrolyte attached to one thereof and a non-conductive alternative or optional seal placed between the electrolyte and electrode assembly and the remaining electrode to complete the cell.

A first modification of the last-mentioned embodiment is the attachment of a non-conductive seal to the non-structural electrolyte. The electrolyte and seal assembly is placed between the appropriate electrodes to complete the cell. In a second modification, the catalysts together with a conductive material are applied directly to each side of the non-structural electrolyte. The electrodes are fabricated with a closed peripheral raised shelf to which is applied a conductive material compatible with those on the electrolyte. This shelf becomes the electrical interface with the conductive catalysts applied to the electrolyte. The electrolyte can be attached to one of the electrodes with the electrode shelf in contact with the associated conductive catalyst. A nonconductive seal is placed between the previously attached electrolyte to electrode and the remaining electrode, with the remaining electrode shelf in contact with the not attached side electrolyte conductive catalyst, thus completing the cell.

Yet another variation is the attachment of a non-conductive seal to the non-structural electrolyte which has the appropriately catalyzed nonstructural solid electrolyte. The electrolyte and seal plate assembly is placed between the appropriate electrodes, with the electrode shelves in contact with the conductive catalysts of the electrolyte to complete the cell.

### BRIEF DESCRIPTION OF THE DRAWINGS

These and other objects, features and advantages of the present invention will become more readily apparent from the following detailed description thereof when taken in conjunction with the accompanying drawings wherein:

FIG. 1 is a perspective, partially sectioned assembly view of a first embodiment of a solid electrolyte fuel cell in accordance with the present invention with negative and positive electrodes and catalysts applied on either side of a structural solid electrolyte which incorporates external electrical connection, fuel and oxidizer passages, returns and exhausts with the fuel and oxidizer passage, and distribution plates themselves being structural components whose geometry matches that of the electrolyte to complete the cell assembly;

FIG. 2 is an exploded perspective view of a flexible electrolyte fuel cell assembly comprising another embodiment according to the present invention which shows formed structural electrode contact plates attached directly to a flexible electrolyte having positive and negative conductive catalysts applied to the top and bottom, respectively, a positive oxidizer distribution plate, arranged on the side adjacent to the positive electrode contact plate, and a fuel distribution plate being on the side adjacent to the negative electrode contact plate as shown in FIG. 19, to form a complete, alignable, repeatable fuel cell module with internal oxidizer and fuel passage and distribution, internal exhaust passages and external electrical interconnect, the distribution plates being either permanently joined to or left independent of membrane-electrode assembly for ease of fuel cell disassembly and maintenance.

FIG. 3 is a perspective, partially sectioned view of a positive electrode assembly in accordance with the present invention in which a multiple part joined or laminated positive electrode is constructed by stacking an oxidizer distribution plate with oxidizer catalysts plates above and below in which the oxidizer catalyst plates are micro-stamped panels which are themselves made of conductive material or are conductive coated and to which the catalyst is applied and in which each of the electrode components share the same geometry;

FIG. 4 is a perspective view showing fuel flow within the fuel cell to demonstrate a unique internal central feed of the present invention;

FIG. 5 is a perspective view of one embodiment of a positive electrode which can be used in constructing a fuel cell in accordance with the present invention;

FIG. 6A is a perspective view of one embodiment of a negative electrode without fuel return passages which can be used in constructing a fuel cell in accordance with the present invention;

FIG. 6B is a perspective view of another embodiment of a negative electrode with fuel return passages;

FIG. 7 is a perspective view of one embodiment of a catalyst and oxidizer passage plate of a multiple part joined or laminated positive electrode assembly for a fuel cell of the present invention;

FIG. 8 is an isolated perspective view of a positive electrode oxidizer distribution plate shown in FIGS. 1, 2, 3 and 18;

FIG. 9 is a perspective view of a catalyst and fuel passage plate of a multiple part joined or laminated negative electrode assembly for a fuel cell according to the present invention;

FIG. 10 is a perspective view of a fuel distribution plate shown in FIGS. 1 and 18;

FIG. 11 is a perspective view of a flexible electrolyte used in a fuel cell of the type shown in FIGS. 2 and 19;

FIG. 12 is a perspective view of a positive electrode cut or formed seal used between cell components in lieu of fixed joinery of a fuel cell utilizing the principles of the present invention;

FIG. 13 is a perspective view of a negative electrode cut or formed seal used between fuel cell components in lieu of fixed joinery of the cell;

FIG. 14 is a perspective view of one of the cell positive (or negative) electrodes which incorporates oxidizer distribution and formed contact top and bottom shelves for a fuel cell constructed according to this invention;

FIG. 15 is an isolated perspective view of a solid electrolyte used in a fuel cell of FIG. 1;

FIG. 16 is a perspective view of a formed non-conductive structural electrode contact plate used in a fuel cell of the type shown in FIG. 2, to which electrode is applied a conductive material in those areas which provide external connection and which come in contact with an electrolyte previously prepared with conductive catalysts applied to each side;

FIG. 17 is a perspective view of a formed non-conductive structural electrode contact plate to which is applied a conductive material in those areas which provide external connection and which come in contact with an electrolyte previously prepared with conductive catalysts applied to each side used, for example, in the fuel cell of FIG. 2.

FIG. 18 is an elevational view of a fuel cell stack assembly utilizing a rigid electrolyte system, also known as a solid oxide rigid electrolyte stack, in accordance with the present invention;

FIG. 19 is a view similar to FIG. 18 but showing a fuel cell stack assembly utilizing a flexible electrolyte system, also known as a flexible electrolyte stack;

FIG. 20 is a schematic perspective view of an assembly line for processing, testing and assembling a fuel cell in accordance with the present invention;

FIG. 21 is a flow chart showing the basic steps of manufacturing process in accordance with the present invention to achieve economical fuel cell products; and

FIG. 22 is a schematic view of a portion of a fuel cell stack of the type shown in FIG. 18 showing in isolation a part thereof to illustrate routing of the fuel, oxidizer and exhaust therethrough.

### DESCRIPTION OF EMBODIMENTS

Although the drawings show a co-annular arrangement of the fuel and air feeds, it is to be understood that the hereinafter fuel and air feeds 42, 43 can also be offset from one another on the z-axis and function efficiently in those situations where greater separation between fuel and oxidizer is desired.

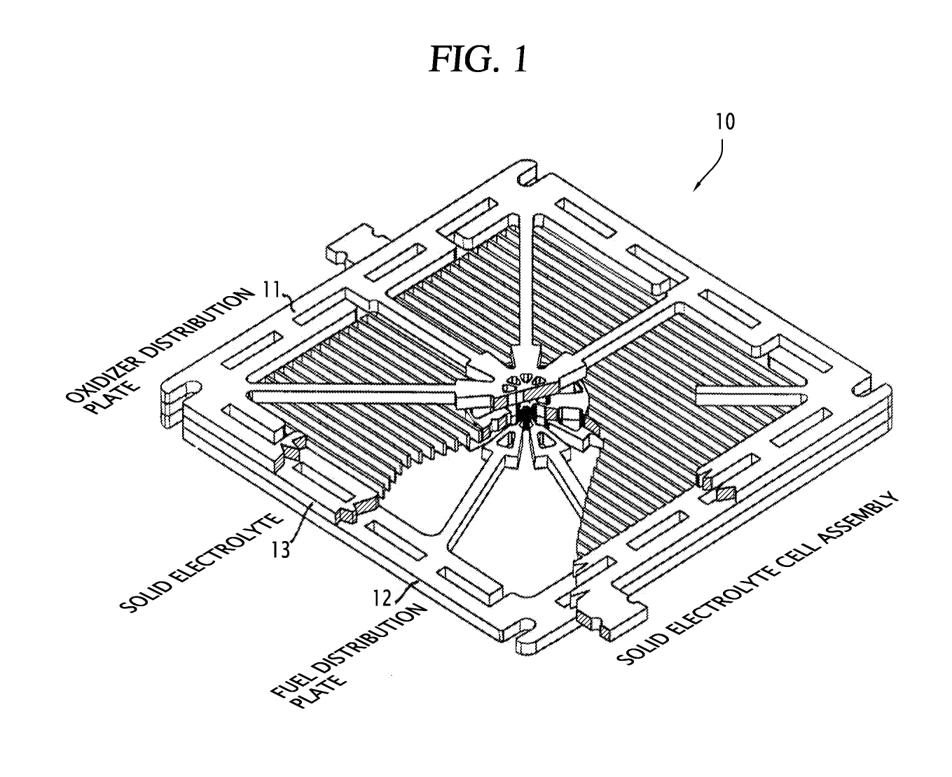

FIGS. 1, 2, and 3 illustrate embodiments of the present invention in which a single relatively compact unitary frame structure is provided with vias and ports for inter-cell fluid passage, fluid distribution, presentation of catalysts, support for the electrolytes, external electrical connections and interlock guides to simplify cell assembly. Each of the components described herein is specifically configured to be fabricated by conventional high-volume, high-speed operations such as stamping for metals and suitable plastics, and rotary die forming of partially staged materials such as ceramics or thermal set polymers similar to the manner in which conventional wheels or baked cookies are formed.

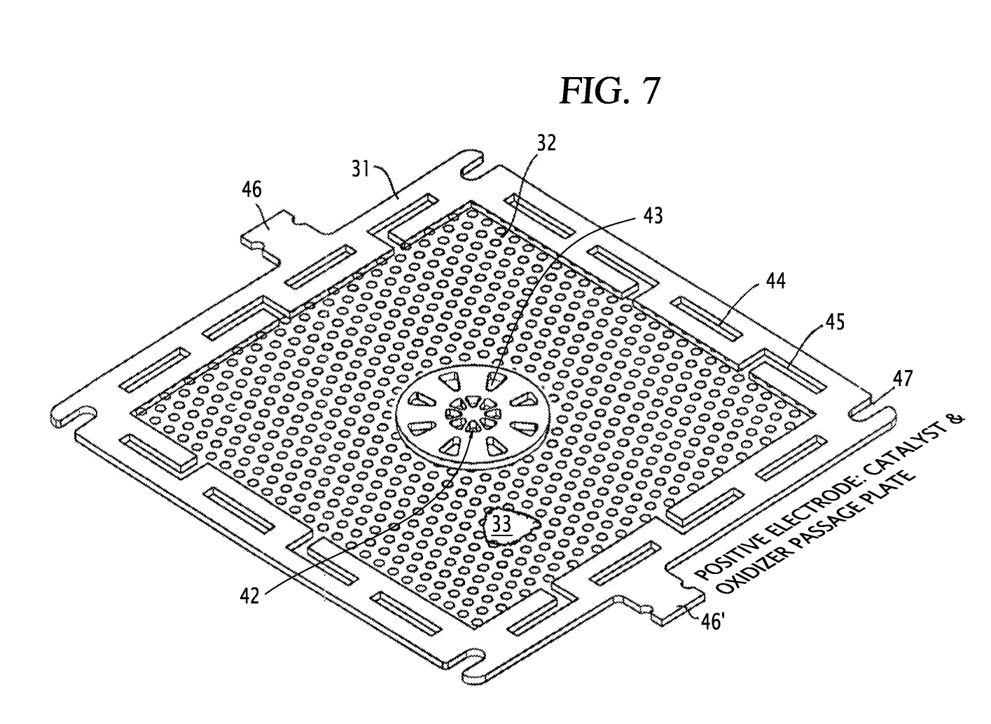

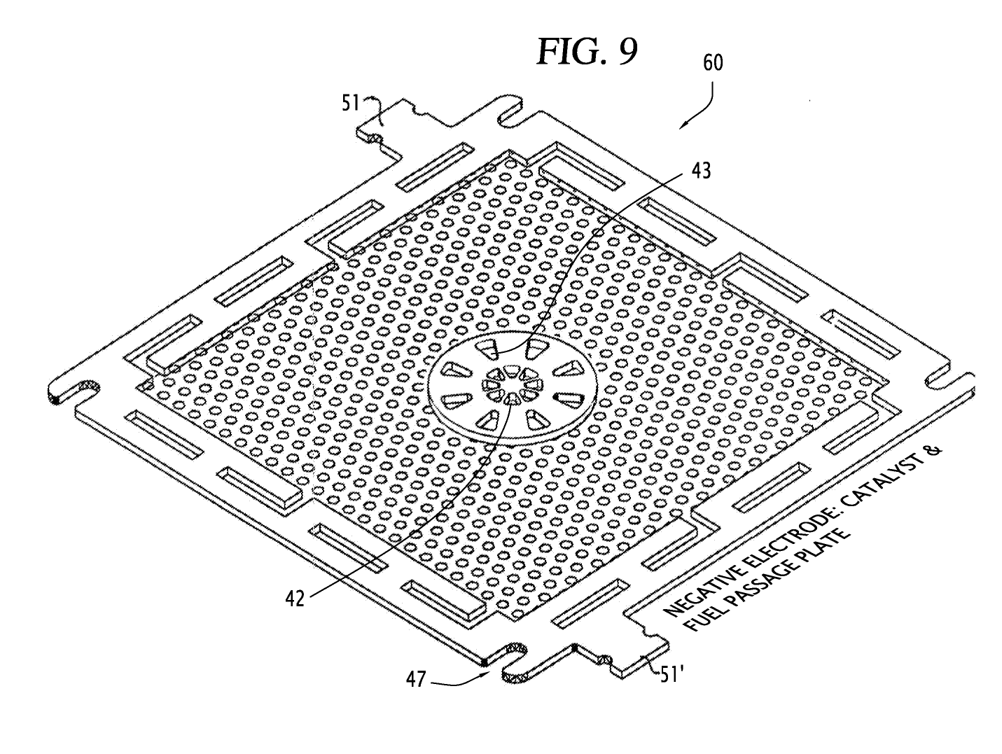

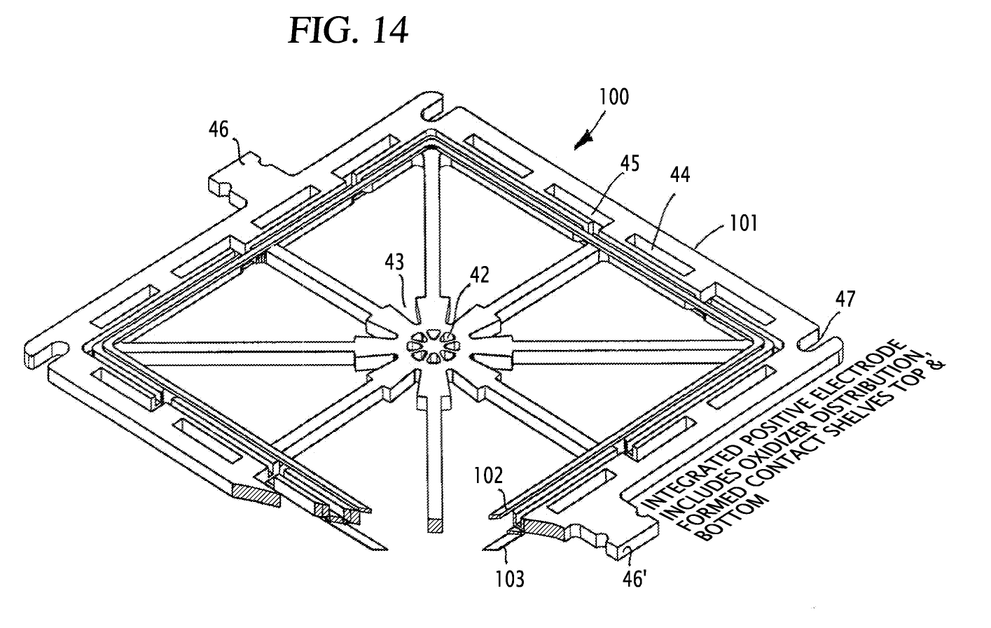

FIG. 1 shows the simplest solid electrolyte cell assembly of the present invention designated generally by numeral 10 in which an oxidizer distribution plate 11 (see also FIG. 8) and a fuel distribution plate 12 (see also FIG. 10) are assembled on either side of a solid electrolyte 13—shown partially broken away—(see the complete solid electrolyte shown isolated in FIG. 15) to which a positive electrode is applied on one side, and a negative electrode to the other side. Thereafter, each the prepared components are assembled together and joined by methods described herein.

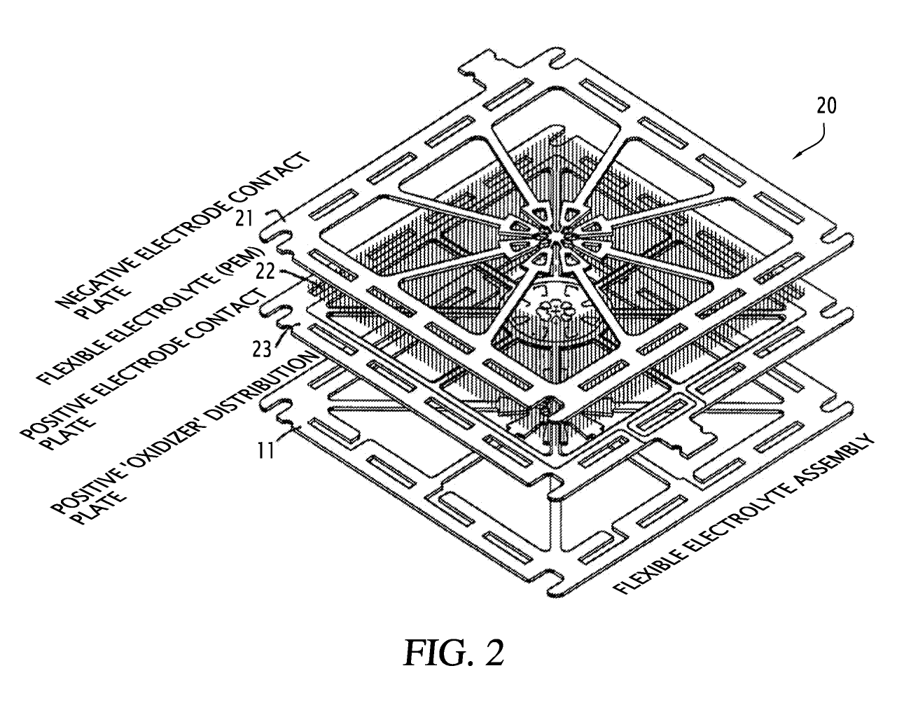

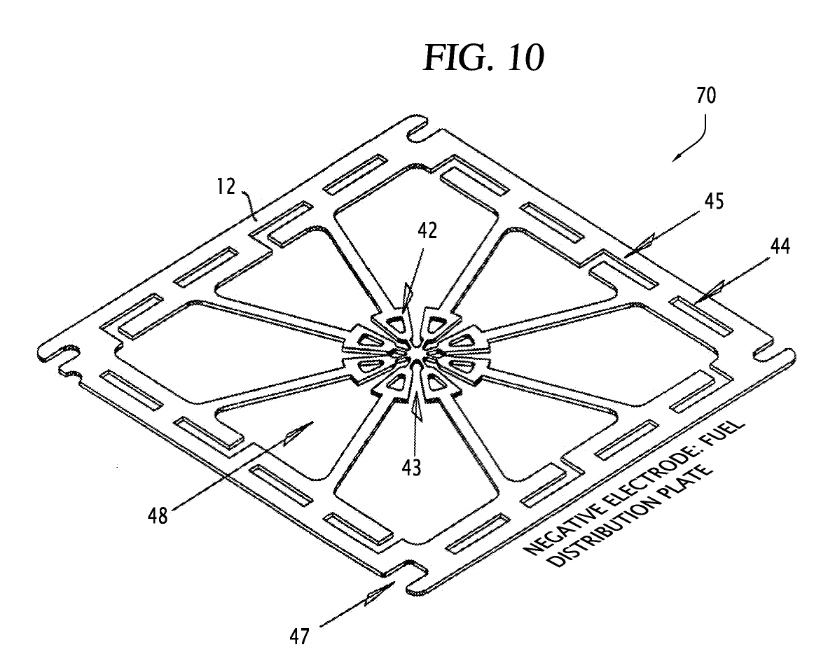

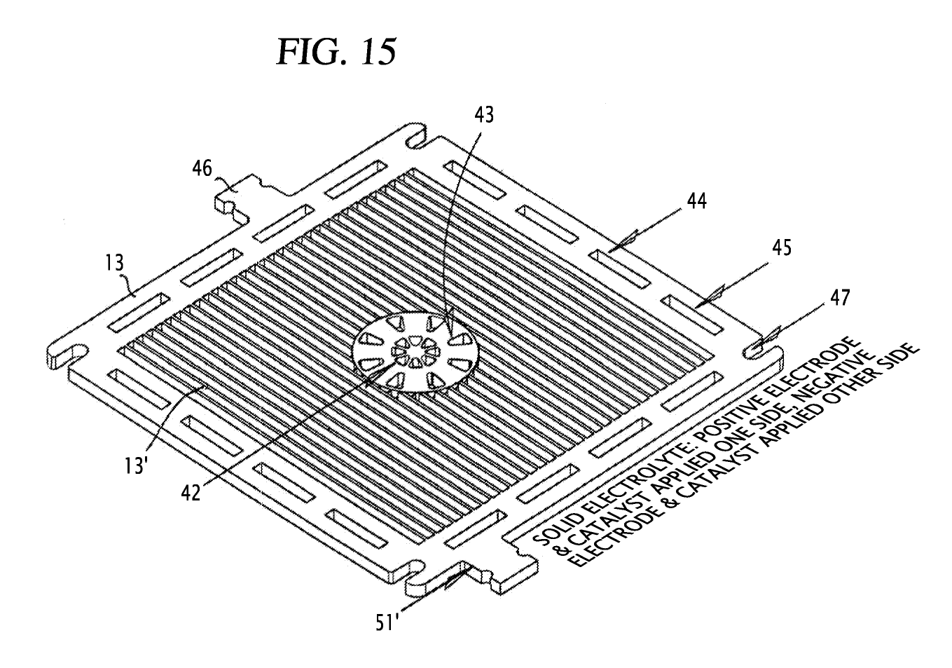

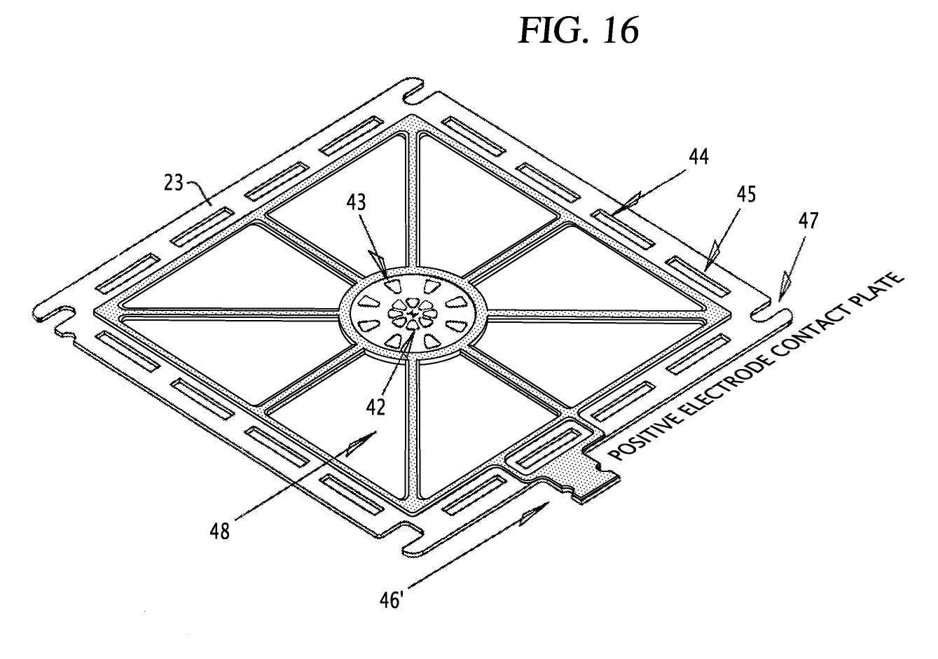

FIG. 2 shows a flexible electrolyte cell assembly of the present invention in which the components designated generally by numeral 20 are fabricated, prepared and joined by methods described herein. These components include a negative electrode contact plate 21 (see FIG. 17), a flexible electrolyte (PEM) 22 (see FIG. 11), a positive electrode contact plate 23 (see FIG. 16) and a positive “oxidizer” distribution plate 11 (see again FIG. 8). Throughout the description identical parts in different embodiments will continue to be designated by the same numerals.

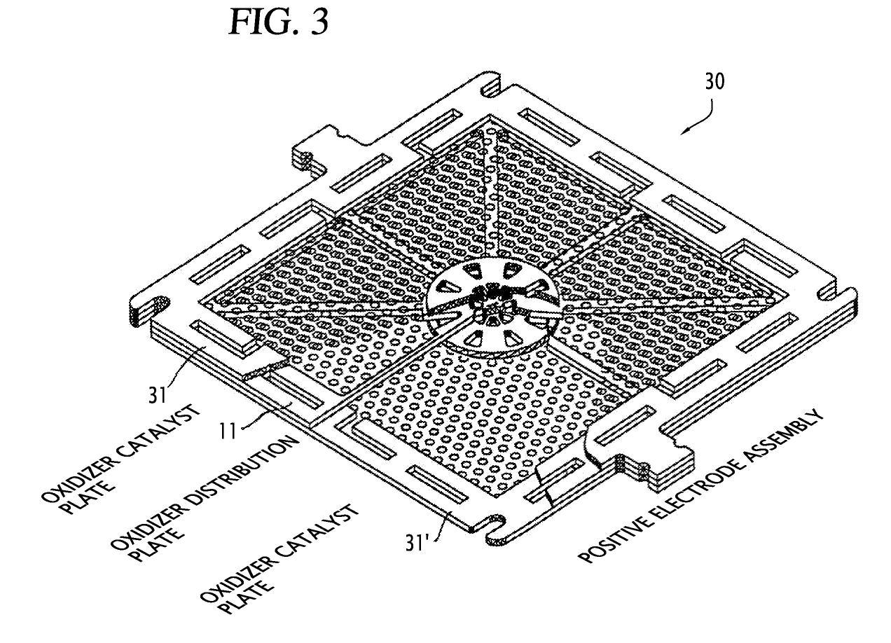

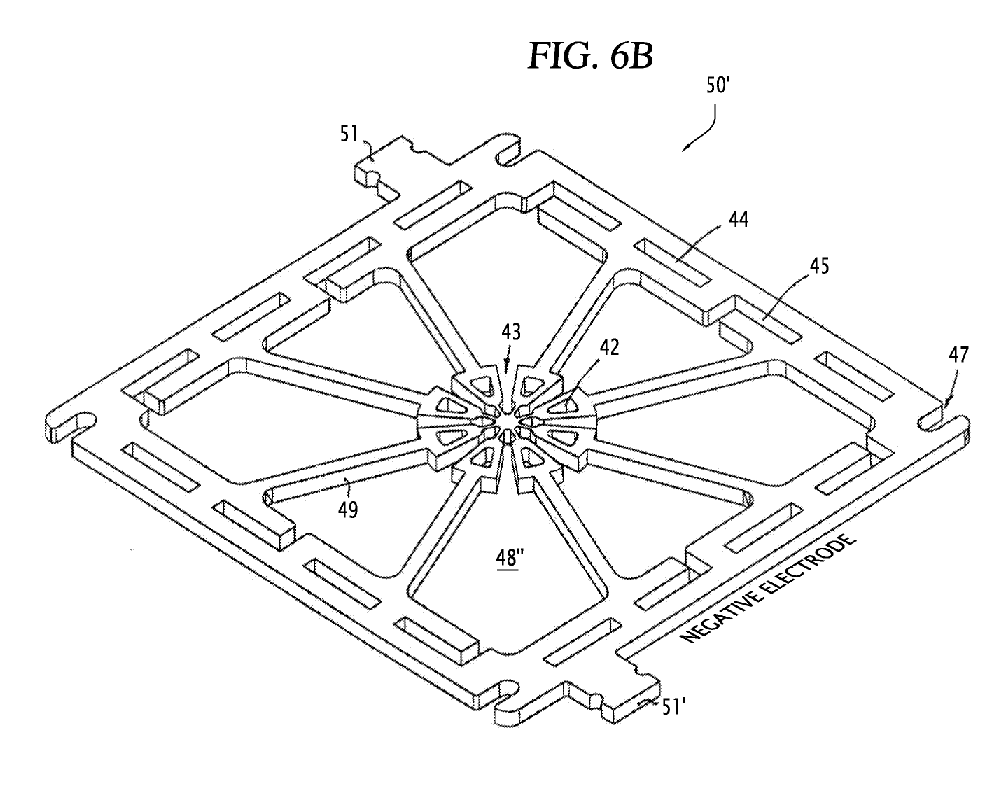

FIG. 3 shows how the components of a positive (or negative) electrode assembly designated generally by numeral 30 are fabricated, prepared and joined by methods described herein. That is, the assembly 30 comprises an oxidizer catalyst plate 31, 31′ (see also FIG. 7) stacked above and below the oxidizer distribution plate 11 (see again FIG. 8). The plates 31, 31′ may also include a catalyst and oxidizer passage area 32, 33 held (see FIG. 7).

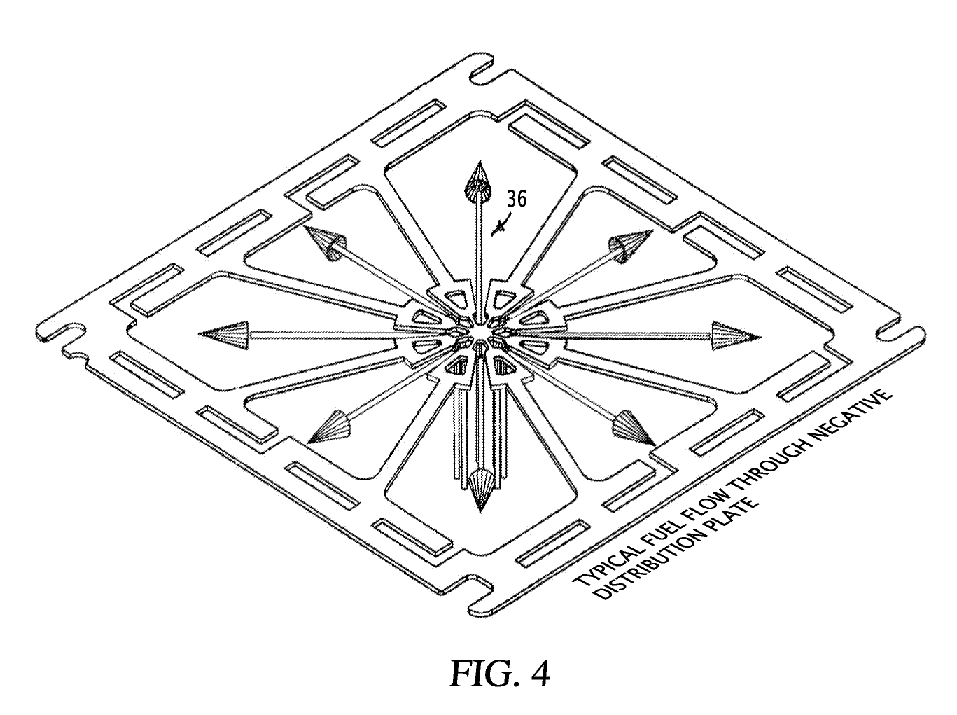

FIG. 4 shows the internal radially-outward flow pattern 36 of the fuel through the internal central feed of a negative distribution plate of the fuel cell configuration in accordance with the present invention. Both the fuel and oxidizer are feed from the center and removed, when needed by certain hydrogen rich fuels or exhausted product from the oxidization process. As noted at the outset, the drawings show a co-annular arrangement of the fuel and air feeds; however, they can also be offset from one another—on the z-axis and function more efficiently in those instances where greater separation between fuel and oxidizer is deemed appropriate.

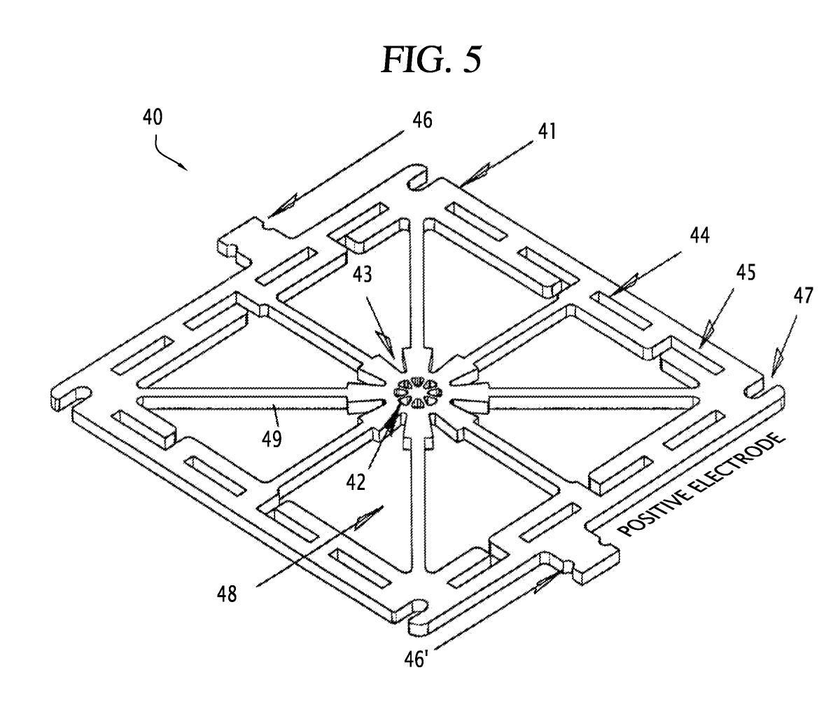

FIG. 5 exemplifies the flexibility embodied in the “unit” approach of the present invention in that the illustrated positive electrodes designated generally by numeral 40. The electrode 40 is produced as a single plate piece by stamping, molding or casting with a solid surround and seal area 41. Vias or conduits 42 are provided in the electrode plate for the plate-to-plate passage of fuel, as seen in FIG. 4, as well as vias or conduits 43 for oxidizer and oxidizer inlet to the fuel cell. Fuel vias 44 and exhaust vias 45 are provided for plate-to-plate passages and openings to the oxidizer exhaust vias. Electrical connecting tabs 46, 46′ are formed integral to the plate and thus require no additional processing. Inclusion of alignment, assembly and clamp structure 47 in the electrode plate reduces complexity and produces a strong structure for the associated cell.

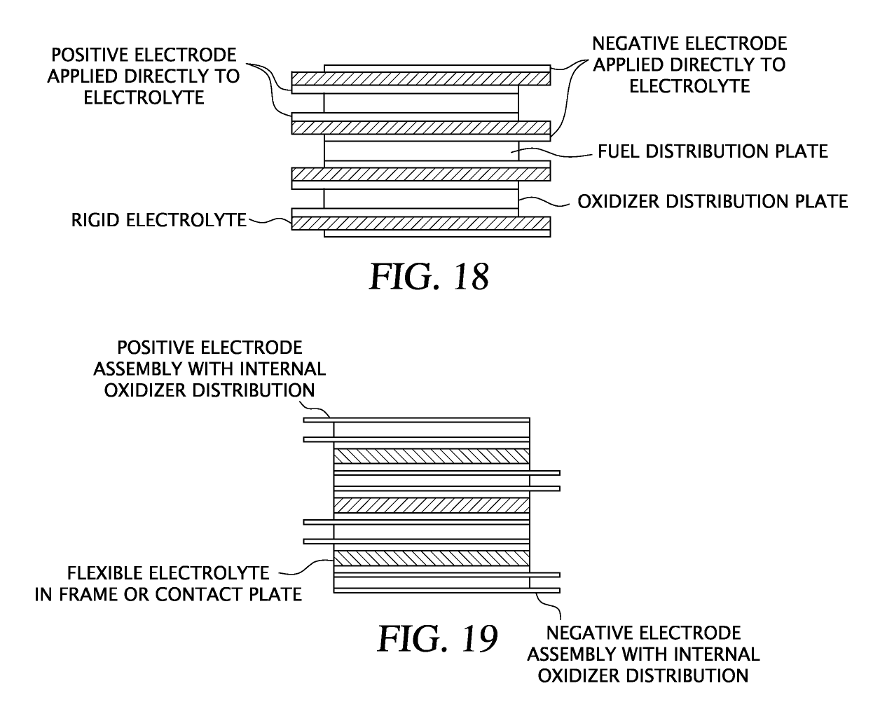

The largest area 48 of the plate 40 is dedicated to the distribution of the oxidizer to the electrolyte i.e., the working area of the fuel cell 40, and is permissive to the passage of the oxidizer while allowing the plate to remain structurally solid and sound due to the cross- and diagonal members 49. The working area 48 is produced as part of the plate by stamping corrugations and holes, molding or casting the plate with variegations and holes, sintering materials, or by other suitable means, or it can be left open. The plate may be produced from conductive materials which reduces the number of process steps or from non-conductive materials to which conductive materials are applied by coating, printing, plating, sputtering or other known means, thereby reducing material costs. The entire working surface may be overlaid with the catalyst by coating, printing, plating, sputtering or other suitable' means unless it is left open. The surface where the components are intended to be attached to one another can be prepared by printing, selective coating, selective plating or other means for joining by brazing, eutectic wetting, plate bonding or other known means. The positive electrode 40 may be stacked with a solid electrolyte and a negative electrode 50′ to form a complete fuel cell. The electrodes are configured to have electrolytes on either side thereof as shown in FIG. 19.

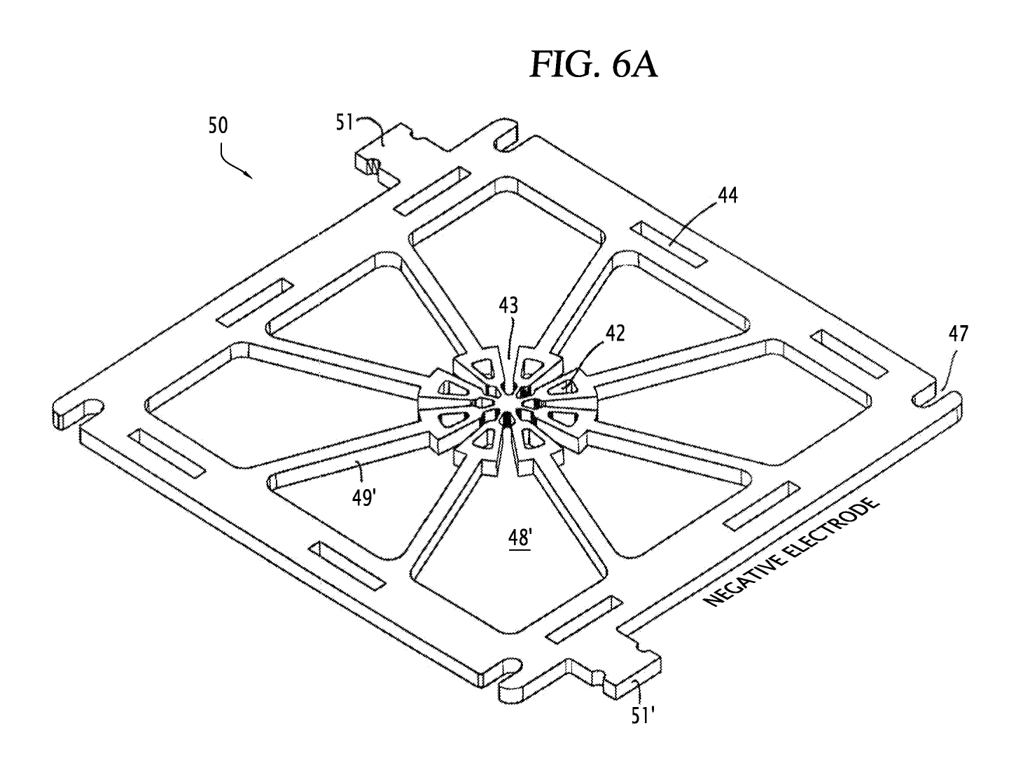

FIG. 6A shows a negative electrode plate designated generally by numeral 50 in which the fuel is completely used and which has a congruent configuration, including vias 42, 43, passages 44, lugs 51, 51′ and structure 47 with the associated cell components, e.g. the positive electrode plate of FIG. 5 which thereby allows the individual components to be stacked. The main differences are the working area where the fuel is presented to the electrolyte 48′, the openings 43 to the fuel vias, the absence of the fuel return passages 45 shown in FIG. 5 due to the total use of fuel and a different position for the electrical connecting tabs 51, 51′, to distinguish them from the positive connecting tabs.

FIG. 6B is similar to FIG. 6A but shows a negative electrode plate designated generally by numeral 50′ for a hydrogen-rich fuel which is therefore returned to the source. Like plate 50, the negative electrode 50′ is congruent in substantial details, i.e. configuration, vias 42, 43, passages 44, 45 and structure 47 with the associated cell components which allows individual components to be stacked. The differences are in the working area 48″ where the fuel is presented to the electrolyte, openings to the fuel vias 42, 43, and electrical connecting tabs 51, 51′ which are distinguished from the connecting tabs 46, 46′ of the positive electrodes (FIG. 5) by being in a different position.

FIG. 7 shows an oxidizer passage plate which is used in combination with the oxidizer distribution plate 11 of FIG. 8 and another oxidizer passage plate and form a complete positive electrode in the manner shown in FIG. 3. The oxidizer passage plate 31 is likewise congruent in details with the oxidizer distribution plate 11 (FIG. 8) and with the associated cell components. The passage area 33 is permissible to the flow of oxidizer and is formed by the same means and as part of the oxidizer passage plate.

We have recognized that one advantage of joined or laminated electrodes is the placement of catalysts away from the electrolyte which thereby allows electrons to be added to the forming oxygen ions prior to combining with the fuel ions at the output of the electrolyte and thus increases efficiency through a normal flow to the discharge passage 45. Another advantage of joined or laminated electrodes which we have recognized is the ability to use extremely high volume production equipment such as stamping machines.

FIG. 8 shows in isolation the oxidizer distribution plate 11 which is similar and congruent with the positive electrode assembly of FIG. 5 in substantial detail, including the vias 42, 43, the passages 44, 45, and the structure 47, can be made conductive or nonconductive and may include electrical connecting tabs. The oxidizer distribution plate 11 shown in FIG. 3 is one example in which is used in combination with two oxidizer passage plates 31 of the type shown in FIG. 7 to form a complete positive electrode and to be stacked with the associated fuel cell components. In another example shown in FIG. 1, the oxidizer distributor plate 11 is used in combination with a structural solid electrolyte 13 and a fuel distributor plate 12 to form a complete fuel cell. In yet another example shown in FIG. 2, the oxidizer distributor plate 11 is used in combination with a flexible membrane electrode assembly to form a complete fuel cell assembly of the type shown in FIG. 19. The working area 48 can be formed as that of the positive electrode in FIG. 5 or can be removed entirely.

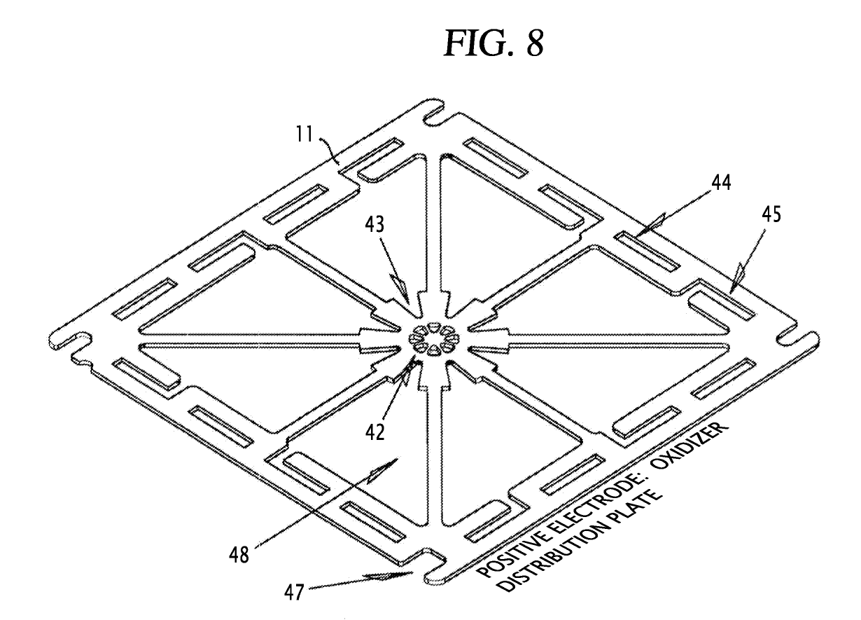

FIG. 9 shows a fuel passage plate designated generally by numeral 60 which is used in combination with the fuel distribution plate designated generally by numeral 70 in FIG. 10 and another fuel passage plate (not individually shown) to form a complete negative electrode. The fuel passage plate 60 is likewise congruent in major details, except for the electrical connecting tabs 51, 51′, with the fuel distribution plate 70 to join a complete negative electrode of the type seen in FIG. 6B and be stacked with the associated cell components. The passage area 48 is permissible to the flow of fuel and formed by the same means and as part of the fuel passage plate.

The above-referenced FIG. 10 shows the fuel distribution plate 70 in isolation. The plate 70 is thus similar and congruent with the negative electrode 50′ in FIG. 6B in certain details, can be made conductive or nonconductive, and may include electrical connecting tabs. In one example, the fuel distribution plate 70 is, as above noted, used in combination with two fuel passage plates 60 shown in FIG. 9 to form a complete negative electrode (similar to the electrode assembly of FIG. 3) and can be stacked with the associated cell components to produce the required power. The working area 48 is formed in the manner of the negative electrode 50′ (FIG. 6B) or removed entirely. In the example of FIG. 1, the fuel distribution plate 12 is used in combination with the solid electrolyte 13 and an oxidizer distributor plate 11 to form a complete fuel cell. The fuel distribution plate can also be stacked with a flexible membrane electrode assembly of the type shown in FIG. 2 to form a fuel cell assembly of the type shown in FIG. 19.

FIG. 11 shows in isolation the already discussed flexible electrolyte 22 which is likewise congruent in significant details 15 with the associated cell electrodes, e.g. 30, 40, 50, 100 to allow the individual components to be stacked to form a fuel cell of the desired power output. The flexible electrolyte 22 is in fact permissible (i.e. permitting passage) to migrating ions and must be physically supported by a structural frame 24 or attachment to an electrode. The advantage of the flexible electrolyte used in the present invention is that it is already a commercially available product.

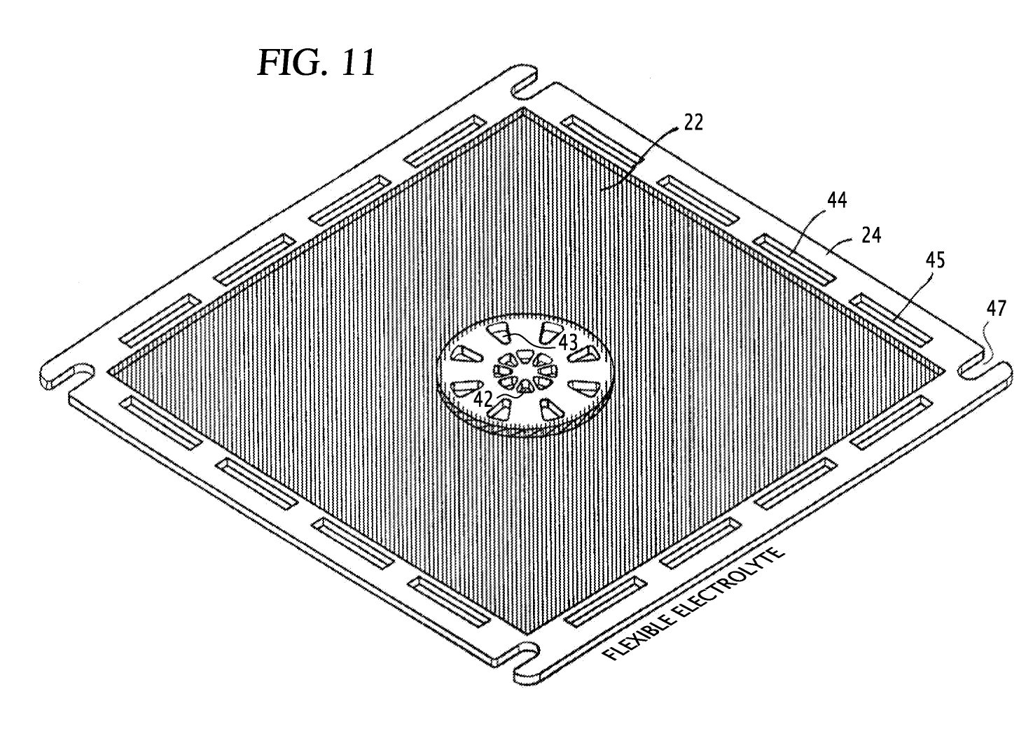

FIG. 12 shows in isolation a positive electrode cut or formed seal designated generally by numeral 80 which may be used between the positive electrode 30, 40, 100 and the flexible electrolyte 22 to form an alternative electrical separation and closure therebetween. This electrode seal is important when used with cell components which are readily damaged or of low electrical resistance, either of which condition might cause fuel cell failure. The positive electrode seal 80 is likewise congruent in significant details to stack and seal the associated cell components.

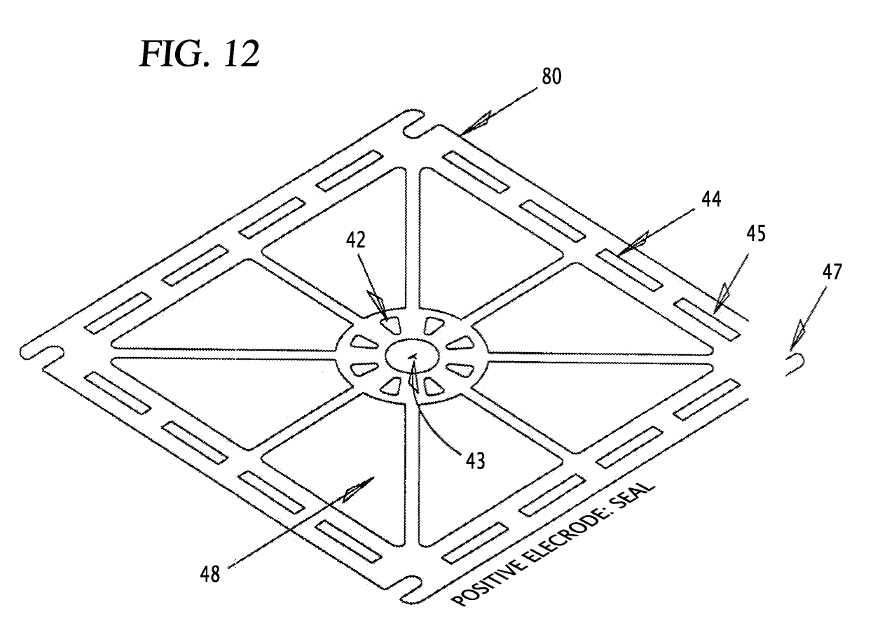

FIG. 13 shows in isolation a negative electrode cut or formed seal 90, which can be, for example, used between the negative electrode 50′ (FIG. 6B) and the flexible electrolyte 22 to form an alternative electrical separation and closure therebetween. The electrode seal is also significant here when used with cell components which are readily damaged or of low electrical resistance, either of which condition might cause fuel cell failure. The negative electrode seal is also congruent in details to stack and seal the associated cell components.

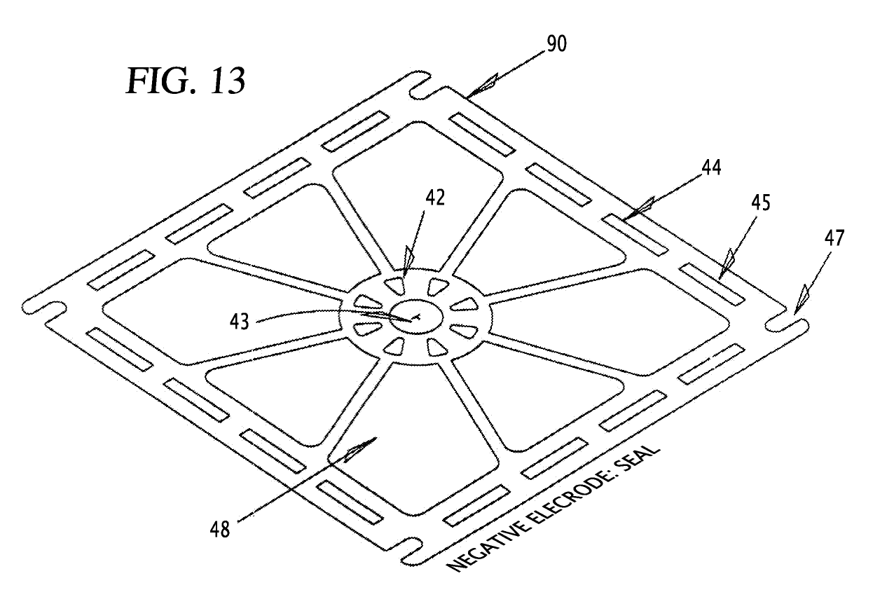

FIG. 14 also exemplifies the method and process flexibility embodied in the “unit” approach of the present invention by describing one of the cell electrodes, specifically a positive electrode 100. The electrode plate 100 is produced as a single piece by stamping, molding or casting with a solid surround and seal area 101. The plate 100 includes the vias or conduits 42, 43 for the plate-to-plate passage of fuel and oxidizer, respectively, as well as the oxidizer inlet to the cell. Also included in the plate 100 are fuel vias 44, and exhaust vias 45 for plate-to-plate passages and openings to the oxidizer exhaust vias. The electrical connecting tabs 46, 46′ are integral to the plate 100 and require no additional work. The previously-described alignment, assembly and clamp structure 47 included in the electrode plate 100 further reduces complexity and produces a strong structure for the associated cell. The largest area of the plate is dedicated to the distribution of the oxidizer to the electrolyte 22. Contact shelves 102, 103 for assuring good mechanical/electrical contact to assure edge collection of current are produced as part of the plate 100 by stamping corrugations or ribs top and bottom or by molding or casting the plate with such nesting ribs. The plate 100 can be produced from conductive materials to reduce the number of process steps or from non-conductive materials to which conductive materials are applied by coating, printing, plating, sputtering or other conventional techniques, again reducing material costs. The entire working surface may be overlaid with the catalyst by coating, printing, plating, sputtering or other techniques. The surface where the components are to be attached to one another can be prepared by printing, selective coating, selective plating or the like for joining by brazing, eutectic wetting, plate bonding or other known ways. The positive electrode 100 may be stacked with a solid electrolyte and a similar negative electrode with contact shelves to form a complete fuel cell. The electrodes are configured to have electrolytes on either side thereof as shown in FIG. 19.

FIG. 15 shows the solid electrolyte structure 13 which is also shown in FIG. 1 and is therefore congruent in significant details with the associated cell distribution plates which allows the individual components to be stacked to accomplish a fuel cell of the desired power output. The solid electrolyte 13′ is in fact permissible to migrating ions and is in every other respect a self-contained structure and, as such can be prepared for applying conductive electrode material or joining to separate electrodes and in turn to other fuel cells to form a power package.

FIGS. 16 and 17, respectively, show the positive and negative electrode contact plates. The plates are made of dielectric (nonconductive) material such as glass, ceramic synthetic resin, etc. to which is applied a described conductive surface, etched or cut foil, ink etc. These plates are then assembled with a solid electrolyte and with the similar material distribution plates, separators, etc. to form a complete cell. A laminating process similar to that used in multi-layer printed circuit board production may be employed.

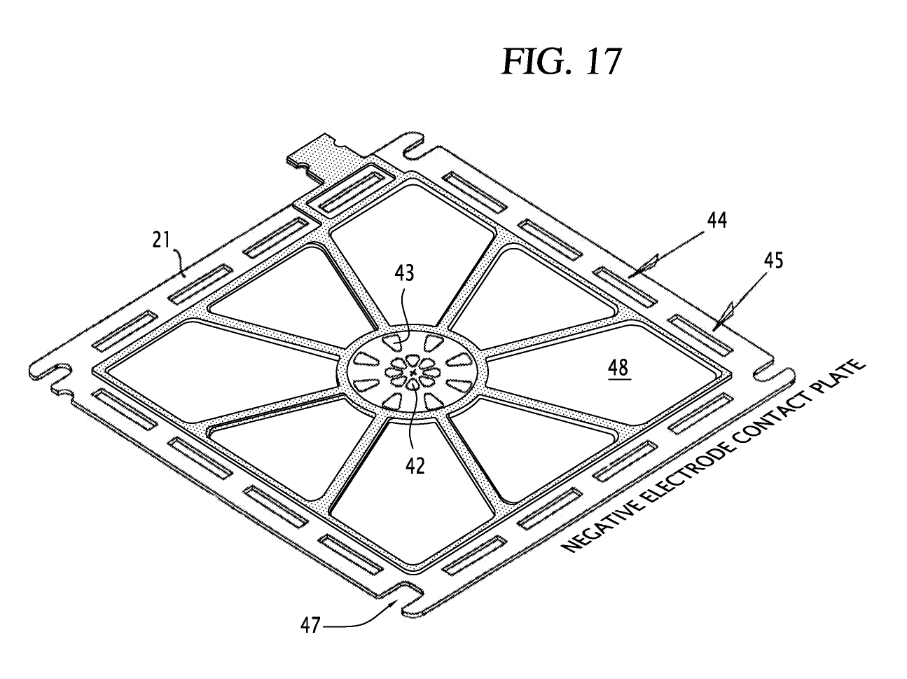

In the rigid electrolyte stack shown in FIG. 18, the fuel cells shown in FIG. 1 are solid oxide fuel cells assembled into a stack. The positive and negative electrodes are applied directly to opposite sides of the rigid electrolyte, and the fuel and oxidizer distribution plates are alternately arranged between the positive and negative electrode sides of the electrolytes so that the positive electrode sides of two opposing electrolytes share an oxidizer distribution plate, and conversely the negative electrode sides of two opposing electrolytes share a duel distribution plate. FIG. 19 shows a flexible electrolyte fuel cell stack using a flexible cell assembly of the type shown in FIG. 2. Alternatively, similar stacks can be made by the alternate assembly of flexible electrolytes with the double sided positive and negative electrodes or electrode assemblies of the types seen in FIGS. 3, 5, 6A, 6B, and 14, so that the positive sides of two opposing electrolytes share a positive electrode, and conversely the negative sides of two opposing electrolytes share a negative electrode. The positive electrode has internal oxidizer distribution, and the negative electrode has internal fuel distribution. The flexible electrolyte (PEM) can be held in a frame or supported by the electrode plate as seen in FIG. 2 or FIG. 11. It is to be understood that the stacks shown in FIGS. 18 and 19 are only portions or segments of a complete stack which can number several hundred fuel cell assemblies. Conventional end caps (not shown) are also put at the terminal sides of the completed stack.

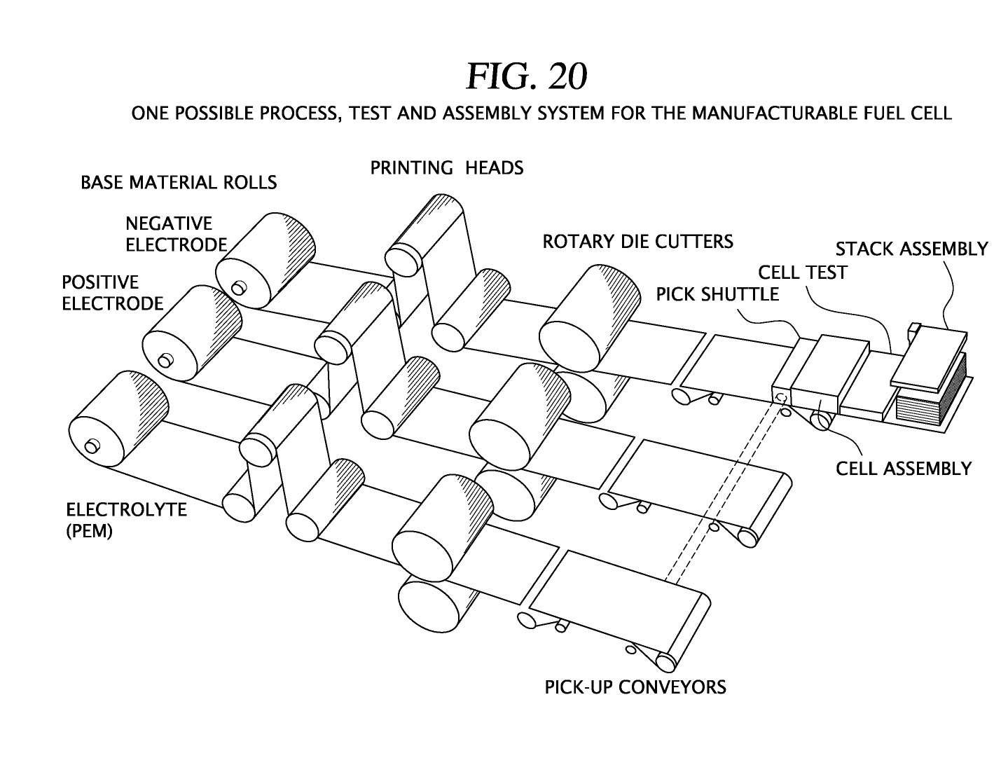

FIG. 20 shows one possible process, test and assembly system for producing the aforementioned fuel cells in a simple, efficient and economical manner in accordance with the present invention. In particular, the PEM, positive electrode and negative electrode substrates are unrolled from large rolls of basic material and passed through printing heads in which the positive and negative catalysts are printed thereon. The printed substrates are then passed through conventional rotary the cutters where they are cut to the appropriate fuel cell size and picked up by conveyors. Conventional conveying technology is utilized to bring the electrolyte between the positive and negative electrodes of the general type shown in FIGS. 2 and 11. The cell assemblies are then picked by a pick shuttle and forwarded to a cell test device prior to assembly into the stack.

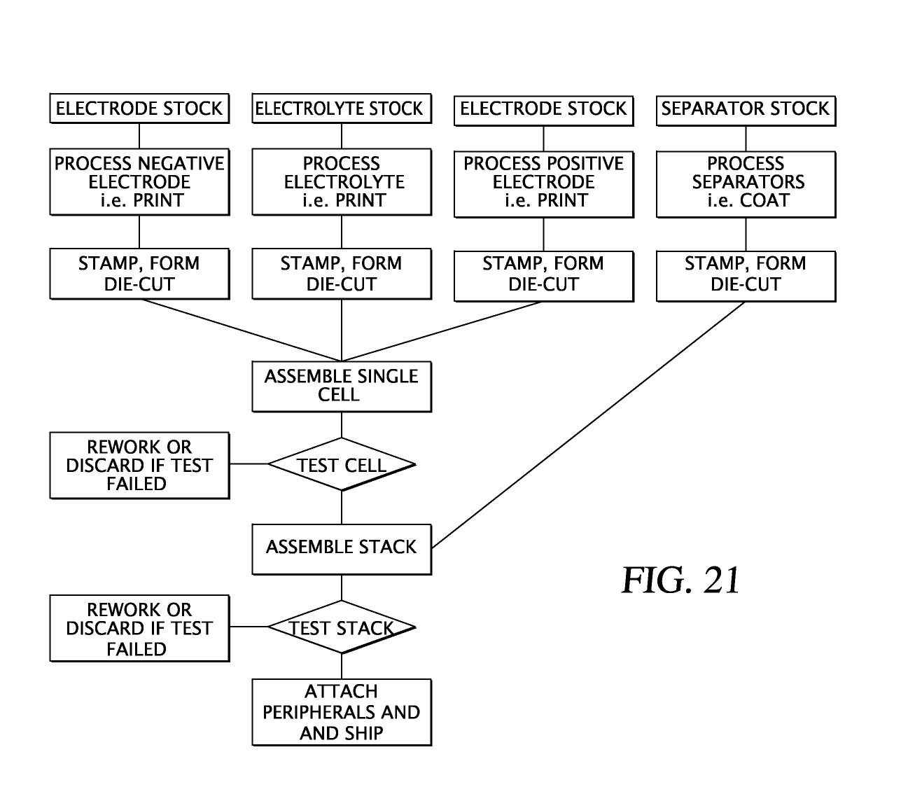

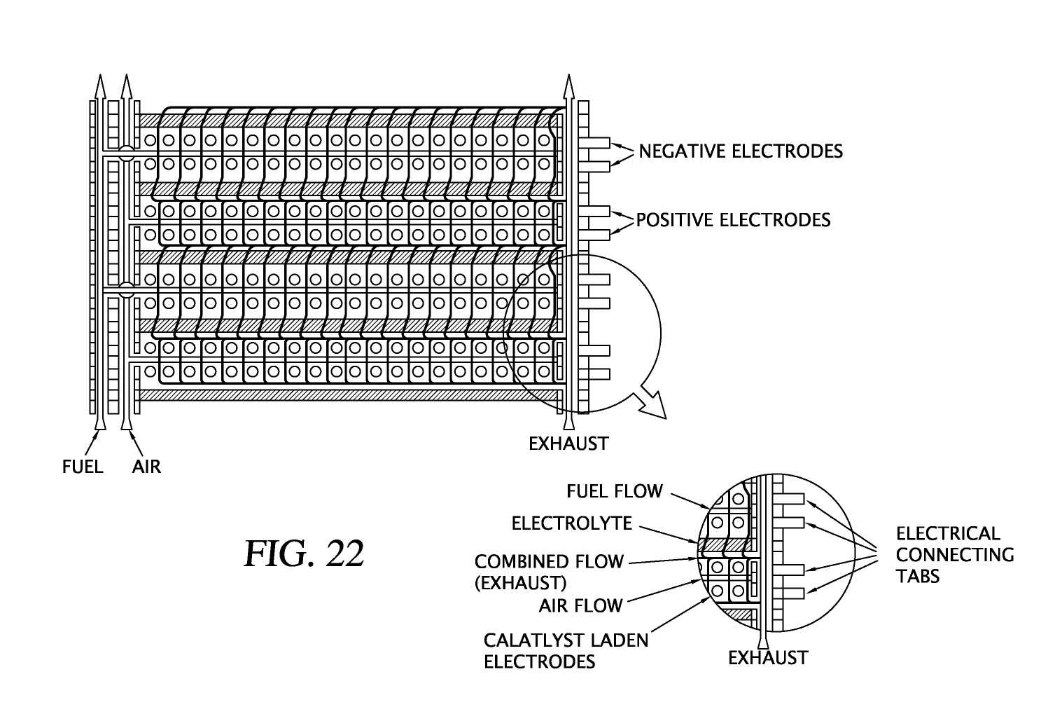

This process is also shown in the flow chart of FIG. 21 which also shows the preparation of separators used in the fuel cell stack, the testing of the stack after assembly and the attachment of peripherals to acceptable or reworked stacks. It will, of course, be understood that the electrolyte and electrodes can come from stock material other than rolls. FIG. 22 illustrates the basic flow of fuel, air and exhaust in a typical fuel cell system manufactured in the above-described manner.

### INDUSTRIAL APPLICABILITY

A fuel cell and a manufacturing method therefore are provided. The fuel cell arrangement is practicably capable, for the first time, of being manufactured in high volume at relatively low cost, and to a high volume process which provides robust and dependable fuel cell construction.

Although the invention has been described and illustrated in detail, it is to be clearly understood that the same is by way of illustration and example, and is not to be taken by way of limitation. The spirit and scope of the present invention are to be limited only by the terms of the appended claims.

What is claimed is:

1. A complete fuel cell, characterized by the following components:
a) a fuel distributor,
b) an oxidizer distributor, and
c) a solid electrolyte operatively arranged between the fuel distributor and the oxidizer distributor.

2. A fuel cell according to claim 1, further characterized in that the solid electrolyte comprises a frame with a central portion, having a positive electrode and catalyst applied on one side of the central portion and a negative electrode and catalyst on a side of the central portion opposed to the one side, fuel and oxidizer vias arranged centrally of the frame, fuel, and exhaust conducts arranged in the frame and electrical contact lugs extending in a direction outwardly of the frame.

3. The fuel cell according to claim 2, characterized in that the oxidizer distributor is arranged on the positive electrode side of the solid electrolyte and comprises an outer frame having alternately arranged fuel conduits and exhaust conduits therein congruent with the fuel and exhaust conduits of the solid electrolyte frame, fuel, and oxidizer vias congruent with solid electrolyte vias, a plurality of members extending between the frame and the vias to define permissible areas for the oxidizer, the exhaust conduits being open at the inner side of the frame to communicate with the permissible area which constitutes a major portion of the area of the oxidizer distributor.

4. The fuel cell according to claim 2, characterized in that the fuel distributor is arranged on the negative electrode side of the central portion and comprises an outer frame having alternately arranged fuel conduits and exhaust conduits therein congruent with the fuel and exhaust conduits of the solid electrolyte frame, fuel, and oxidizer vias congruent with solid electrolyte vias, and a plurality of members extending between the frame and the vias to define permissible areas for the fuel, the exhaust conduits being open at the inner side of the frame to communicate with the permissible area which constitutes a major portion of the area of the fuel distributor.

5. The fuel cell according to claim 1, characterized in that the fuel distributor, the oxidizer distributor and the solid electrolyte components are so configured as to provide a complete rigid or flexible electrolyte fuel cell construction, in which said components (a), (b), and (c), and subassemblies thereof, constitute an alignable, sealable, modular structure, with alignment and interlock guides, internal fuel feed passages, fuel distribution passages, oxidizer feed passages, oxidizer distribution passages, return passages, and exhaust passages contained in the modular structure, electrode and catalyst materials contained in the said structure, and electrical connection tabs accessible externally of the modular structure.

6. The fuel cell according to claim 5, characterized in that the fuel feed, fuel distribution, oxidizer feed, oxidizer distribution, return and exhaust passages are internally configured in and formed by said components (a), (b), and (c), so that when said components are aligned and stacked to form a complete cell and stacks of cells or modules, passages of adjoining components, adjoining cells, and adjoining stacks or modules are congruent and form integrated plate-to-plate, cell-to-cell, stack or module-to-module corresponding passages, therefore eliminating the need for external inlets and outlets as well as associated external piping to and from each cell component, complete cell, stack or module.

7. The fuel cell according to claim 5, characterized in that said components are formable into one of a single fuel cell, a fuel cell stack, or a fuel cell module, with end components located at each end of a completed cell stack or module, said end components being internally configured to connect the fuel feed passages, the oxidizer feed passages, the return passages, and the exhaust passages to corresponding external fittings and having compressive connection means for connecting between closure pieces and the remainder of the fuel cell assembly.

8. The fuel cell according to claim 2, characterized in that the vias, which are defined by integral structure of the distributors and the solid electrolyte, are concentrically arranged, in a radially extending pattern, and in substantially the same plane.

9. A fuel cell according to claim 1, characterized in that the solid electrolyte comprises a frame with an ion-permissive central portion, a positive electrode material and catalyst applied either to a first side of the central portion or to the oxidizer distributor, and a negative electrode material and catalyst applied either to a second side of the central portion or to the fuel distributor; with fuel feed, oxidizer feed, return and exhaust passages arranged in the frame.

10. The fuel cell according to claim 9, is characterized in that the oxidizer distributor is arranged on one side of the central portion and comprises an outer frame having alternately arranged fuel conduits and exhaust conduits therein congruent with the fuel and exhaust conduits of the solid electrolyte frame, fuel and oxidizer vias congruent with solid electrolyte vias, a plurality of members extending between the frame and the vias to define passage areas for the oxidizer, electrical contact lugs extending outwardly from the frame; said oxidizer distributor being composed of nonconductive material, or of nonconductive material with conductive and catalytic material applied on both sides, or of conductive material to which catalytic material is applied on both sides, thus serving, as an oxidizer distributor and structural support and electrical interconnect, or as a positive electrode with internal oxidizer distribution.

11. The fuel cell according to claim 9, is characterized in that the fuel distributor is arranged on an opposite side of the central portion and comprises an outer frame having alternately arranged fuel conduits and exhaust conduits therein congruent with the fuel and exhaust conduits of the solid electrolyte frame, fuel and oxidizer vias congruent with solid electrolyte vias, a plurality of members extending between the frame and the vias to define passage areas for the fuel, electrical contact lugs extending outwardly from the frame; said fuel distributor being composed of nonconductive material, or of nonconductive material with conductive and catalytic material applied on both sides, or of conductive material to which catalytic material is applied on both sides, thus serving, as an fuel distributor and structural support and electrical interconnect, or as a negative electrode with internal fuel distribution.

12. The fuel cell according to claim 10, characterized in that the oxidizer distributor with electrode or the positive electrode with the internal oxidizer distribution is comprised of three separate components, namely a first oxidizer plate, a second oxidizer plate identical with the first oxidizer plate, and an oxidizer distribution plate operatively arranged between the first and second oxidizer plates, the three separate components being configured to be joined together so as to form a modular oxidizer distributor and electrode assembly or modular positive electrode assembly with internal oxidizer distribution.

13. The fuel cell according to claim 11, characterized in that the fuel distributor with electrode or negative electrode with internal fuel distribution is comprised of three separate components, namely a first fuel plate, a second fuel plate identical with the first fuel plate, and a fuel distribution plate operatively arranged between the first and second fuel plates; the three separate components being configured to form together a modular fuel distributor and electrode assembly or modular negative electrode assembly with internal fuel distribution.

14. The fuel cell according to claim 10, characterized in that the oxidizer distributor with electrode, or the positive electrode with internal oxidizer distribution, includes contact shelves on both sides thereof to provide an alternative attachment option for the solid electrolytes.

15. The fuel cell according to claim 11, characterized in that the fuel distributor electrode, or the negative electrode with internal fuel distribution, includes contact shelves on both sides, thereof providing an alternative attachment for the solid electrolytes.

16. The fuel cell according to claim 9, characterized in that the solid electrolyte, distributors and assemblies thereof are configured such that a fuel side of one electrolyte is arranged to face a fuel side of a succeeding electrolyte, thereby enabling use of one common fuel distributor, and further wherein the oxidizer side of one electrolyte is configured to face the oxidizer side of a succeeding electrolyte, thereby enabling use of one common oxidizer distributor, thus reducing size and weight of a complete fuel stack.

17. The fuel cell according to claim 9, characterized in that the electrode-containing and conductive components and component assemblies thereof incorporate externally selectable and connectable electrical tabs which extend outwardly of the component frames are positioned and configured as to always uniquely identify a negative and a positive, and are congruent with like contact tabs of adjoining cell components and cells, thus enabling externally directed edge conductive current collection which eliminates internal cell-to-cell electrical contact with resultant thermal, resistive, corrosive failures, and bipolar separators.

18. The fuel cell according to claim 16, characterized in that common anode and cathode plenums and externally selectable and connectable current collection tabs can be configured to provide electrical connectability every two cells in series, thereby effectively doubling as an active stack area, with at least two-cell building blocks being configured as modular, replaceable units.

19. The fuel cell according to claim 5, characterized in that the oxidizer and fuel distributors are configured to facilitate fluid flow for desired surface distribution, fuel utilization and removal of increased exhaust fluid volume without the use of air compressors and fuel expanders.

20. The fuel cell according to claim 5, further characterized in that a fuel re-circulation loop is configured to act as a heat transfer medium, with excess cathode flow being used for heat removal

21. The fuel cell according to claim 5, characterized in that a nonconductive seal and closure member is arranged between and substantially congruent with adjoining fuel cell components or fuel cell assemblies to obtain alternative electrical separation and enclosure.

22. The fuel cell according to claim 5, characterized in that the seal or closure member at all passages, enclosures, vias and surrounds are accomplished simultaneously with compressible formed material, adhesives, chemical bonding, eutectic bonding, or metal bonding.

23. The fuel cell according to claim 9, characterized in that the distributors or electrodes are formed by stamping, sintering, casting, molding, multi-layer laminating, or etching,
characterized in that a working area is be produced as part of a plate by stamping corrugations and holes, molding or casting the plate with variegations and holes, sintering materials, or it can be left open;
characterized in that the plate is produced from conductive materials or from non-conductive materials to which conductive materials are applied by coating, printing, plating, or sputtering;
characterized in that a surface where the components are attached to one another is prepared by printing, selective coating, selective plating for joining by brazing, eutectic wetting, or plate bonding.

24. A method of manufacturing a fuel cell, characterized by:
(1) passing a solid electrolyte, positive electrode and negative electrode substrates through printing heads in which positive and negative catalysts are printed thereon;
(2) passing the printed substrates through rotary cutters where they are cut to fuel cell size and picked up by conveyors;
(3) bringing the electrolyte between the positive and negative electrodes; and to form a cell assembly;
(4) testing the cell assembly; and
(5) assembling a fuel distributor and a fuel oxidizer on the cell assembly to form a complete fuel cell.

25. The method according to claim 24, further characterized in that the solid electrolyte and the positive and negative electrodes are unrolled from rolls of material.
